(19) United States
(12) Patent Application Publication
(10) Pub. No.: US 2010/0129645 A1
(43) Pub. Date: May 27, 2010

(54) COATING FOR VAPOR CONDENSERS

(76) Inventors: Rudolf Gensler, Singapore (SG); Arne Grassmann, Essen (DE); Manfred Waidhas, Nürnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/593,982

(22) PCT Filed: Mar. 28, 2008
(86) PCT No.: PCT/EP08/53697

§ 371 Date: Sep. 30, 2009

(30) Foreign Application Priority Data
Mar. 30, 2007 (DE) 10-2007-015-450.1

(51) Int. Cl. B32B 5/00; C25D 15/00; B29C 63/26; B05D 1/02; B05D 1/30; C09D 1/00; C08L 75/04

(52) U.S. Cl. 428/336; 204/489; 264/241; 427/427; 427/427.4; 427/420; 106/287.34; 524/589

(57) ABSTRACT

A method for producing a hydrophobic coating for condensers to obtain a dropwise condensation, a hydrophobic coating for condensers, a hydrophobically-coated condenser, and a coating agent are provided. A coating agent is applied to a condenser. The coating agent includes a liquid solvent and a coating material. The coating material may be applied by a wet-chemical method.

### CROSS REFERENCE TO RELATED APPLICATIONS

This application is the US National Stage of International Application No. PCT/EP2008/053697, filed Mar. 28, 2008 and claims the benefit thereof. The International Application claims the benefits of German application No. 10 2007 015 450.1 DE filed Mar. 30, 2007, both of the applications are incorporated by reference herein in their entirety.

### FIELD OF INVENTION

The invention relates to a method for producing a hydrophobic coating for condensers to obtain dropwise condensation as well as to coatings produced.

### BACKGROUND OF INVENTION

With condensation systems the medium that is condensing precipitates onto the thermal transfer surfaces. With steam turbines condensed water vapor from the turbine is typically condensed onto the condenser. Usual condensers contain a plurality of condenser tubes that are primarily made of metal, mostly of alloys of steel or titanium.

With condensations a distinction can be made between dropwise condensation and film condensation. On metallic materials with high surface energy it is primarily film condensation that occurs. The condensate in such cases forms a contiguous liquid film on the metal surface. With dropwise condensation on the other hand, droplets are formed which run away quickly, which increases the efficiency of the condenser.

In the prior art hydrophobic coating of condenser tubes is known to bring about dropwise condensation.

For example silicon coatings of condensation surfaces are known from publication DE 833 049. The technique of coating condensers with tetrafloroethylene resins (Teflon) is also known. The disadvantage here is that the application of this additional layer of material to the condenser leads to an additional thermal transfer resistance. Furthermore hydrophobic-effect coatings frequently have a limited stability.

To avoid these disadvantages the production of hydrophobic coatings by Chemical Vapor Deposition (CVD) has been proposed. Also known, from publication WO 99/18252 for example, is the technique of achieving dropwise condensation by ion implantation of surfaces.

### SUMMARY OF INVENTION

Both methods must however be carried out in a vacuum, resulting in a greater effort for the method and high costs. Use in large-scale installations cannot be made possible at affordable cost.

The object of the present invention is to overcome at least one disadvantage of the prior art. The object of the present invention is in particular to provide a coating which brings about a droplet-type condensation and allows as low-cost a coating as possible.

This object is achieved by a method for producing a hydrophobic coating of condensers to achieve dropwise condensation, with a coating agent being applied by means of wet-chemical methods to the condenser, comprising a liquid solvent and at least one coating material selected from the group comprising silicon-oxide-sol-based sol-gel materials, fluorocarbon polymers, silicones and/or polyurethane-forming components, with, in relation to the total weight of the coating agent in each case:
the solid content of the silicon-oxide-sol-based sol-gel material ranging from ≧0.5 wt. % to ≦20 wt. %; and/or
the fluorocarbon polymer content ranging from ≧0.1 wt. % to ≦5 wt. %; and/or
the solid content of silicon ranging from ≧5 wt. % to ≦30 wt. %; and/or
the polyurethane-forming components content ranging from ≧3 wt. % to ≦30 wt. %.

A further object of the present invention relates to a hydrophobic coating to obtain dropwise condensation with condensers, with the coating being selectively produced from the group comprising silicon-oxide-based sol-gel lacquer, fluorocarbon polymers, silicones and/or polyurethane based lacquers using an inventive method and with the coating having a depth ranging from ≧100 nm to ≦5 μm.

Further advantageous embodiments of the invention emerge from the subclaims

It has surprisingly been found that inventive methods for producing a hydrophobic coating of condensers to achieve dropwise condensation, with a coating agent being applied by means of wet-chemical methods to the condenser, comprising at least one coating material selected from the group comprising sol-gel materials based on silicon oxide sol, fluorocarbon polymers, silicon and/or polyurethane-forming components, are suitable for creating very thin coatings. This is of particular advantage for the hydrophobic coating of condensers since a thicker layer creates a heat conductivity resistance which can lead to the condensation progressing less effectively overall.

Furthermore it is of particular advantage for the coating of condensers for thin, hydrophobic coatings to be able to be applied to condensers by the inventive method which can still withstand the temperature fluctuations and dimensional changes occurring with condensers. This is of great advantage especially for the long-term stability of the coating of condensers.

In addition it is of particular advantage for the coating of condensers that thin, hydrophobic coatings are able to be applied to condensers by the inventive method which can exhibit a high impact resistance and can provide protection for the condenser in this way.

Coating agents, which comprise a liquid solvent and at least one coating material, are understood within the context of this invention especially to be liquids such as solutions, as well as mixtures of materials, which in a liquid phase like a liquid solvent, feature solid-type, gel-type of liquid substances contained in a liquid solvent, for example dispersions such as emulsions or suspensions, sols, sol-gel materials or colloids. The coating agents are preferably liquid in the application state, so that coating materials to be applied are able to be applied from or in the form of a liquid.

The solvent is a liquid solvent. The term “liquid” within the meaning of the present invention means that the solvent is liquid within a temperature range from 0° C. to 100° C., preferably at room temperature, i.e. in a temperature range from 18° C. to 25° C.

This enables the coating material to be dissolved, emulsified or suspended in the solvent. This also allows the coating material to be applied using wet-chemical processes. The term “dissolve” within the meaning of the present invention is to be understood as meaning that the coating material is dissolved, dispersed, emulsified or suspended. Preferably a solvent able to be used is a solution agent.

The solid content is determined for the respective coating agent in accordance with usual methods known to the person skilled in the art, for example by removing the solvent. The solid content typically relates to the dry weight of the coating material, with the dry weight being determined at a temperature which does not lead to the destruction of the coating material. The solid content of usable sol-gel materials is determined for example by evaporating the solvent essentially in compliance with DIN ISO 3251, preferably by evaporating the solvent at 125° C. within a period of 1 hour. Preferably the solid content corresponds to the coating remaining on application to a substrate.

One advantage that can be provided by the coating agent is that smooth coatings are able to be applied.

A further advantage that can be provided is that a coating is able to be produced more easily and at lower cost with a coating agent which is present in the faun of a liquid in its application state than a coating in a vacuum for example.

A term sol-gel materials based on silicon-oxide sol is to be understood within the meaning of the present invention as the sol-gel material or sol-gel system being able to be present in sol and/or gel form. Preferred sol-gel materials are silicon-oxide sols, especially silicon dioxide sols, preferably modified especially functionalized silicon-oxide sols.

Sol-gel material able to be used as a coating material based on a silicon-oxide sol preferably comprises an alcoholic and/or aqueous silane solution, preferably based on alkylsilanes and/or alkoxysilanes. Preferably the silicon-oxide sol comprises polysiloxanes, especially wetted polysiloxanes, which preferably feature organic functionalizing groups linked to the silicon via carbon compounds, especially alkyl groups, for example methyl groups of fluor atoms. The sol-gel material is preferably a precondensed polysiloxane

Usable sol-gel materials on the basis of silicon-oxide sols can be functionalized, preferably alkyl and/or fluorofunctionalized. Preferably the sol-gel material features fluoroalkyl and/or fluoralkoxysilanes. Advantageously alkylsilanes and/or fluoroalkylsilanes can bring about an improvement of the hydrophobicity of the embodied sol-gel lacquer.

Preferably usable sol-gel materials comprise at least one silane compound, preferably alkoxysilane, at least one functionalized silane compound, preferably selected from the group comprising alkysilanes and/or fluoralkysilanes, at least one alcohol, at least one acid and/or water.

Preferably usable alkoxysilanes are selected from the group comprising tetramethoxysilane (TMOS), tetraethoxysilane (TEOS), methyltriethoxysilane (MIES) and/or Methyltrimethoxysilane (MTMS). An especially preferred alkoxysilane is tetraethoxysilane.

Preferably usable alkylsilanes are selected from the group comprising octyltriethoxysilane, octyltrimethoxysilane, phenyltrimethoxysilane, propyltriethoxysilane, hexadecyltrimethoxysilane, octadecyltrimethoxysilane and/or 3-glycidyloxypropyltriethoxysilane. A preferred fluoralkylsilane is for example tridecafluoroctyltriethoxysilane.

Preferably usable sol-gel materials comprise at least one alkoxysilane compound ranging from ≧50 wt. % to ≦80 wt. %, at least one alkylsilane and/or fluoralkylsilane ranging from ≧0.5 wt. % to ≦30 wt. %, alcohol ranging from ≧10 wt. % to ≦70 wt. %, acids ranging from ≧0 wt. % to ≦10 wt. % and/or water ranging from ≧1 wt. % to ≦30 wt. %, related to the total weight of the sol-gel material, with the contents by weight of the individual components being selected so that the total weight of the components does not exceed 100 wt. %.

In preferred embodiment the solid content of the sol-gel material based on silicon oxide sol ranges from ≧5 wt. % to ≦15 wt. %, preferably ranging from ≧7 wt. % to ≦10 wt. %, in relation to the total weight of the coating agent.

It has been shown that especially a solid content ranging from ≧7 wt. % to ≦10 wt. %, related to the total weight of the sol-gel material can lead to coating thicknesses of the formed sol-gel Lacquer of 5 μm or less being able to be embodied.

Preferred solvents for sol-gel materials based on silicon-oxide sol are selected from the group comprising water, ketone, alcohols and/or acids, especially preferred solvents are selected from the group comprising water, 2-butanone, isopropanol, ethanol, methoxypropanol, ethylhexanol, hydrochloric acid, acetic acid and/or nitric acid.

Drying and/or hardening of the sol-gel material leads to a coating with the formation of a sol-gel lacquer.

In further advantageous embodiments of the invention the coating agent contains a fluoropolymer as coating material. The contained fluoropolymer can be embodied from a crystalline, a half-crystalline and/or an amorphous fluoropolymer material.

Fluoropolymers of preferred which are soluble or dispersible in organic solvents, especially in perfluorinated hydrocarbons. Especially preferred are fluoropolymers, especially amorphous fluoropolymers which are soluble in organic solvents. Preferably the fluoropolymer is present in the coating agent in the form of a solution or a dispersion.

In preferred embodiments the fluoropolymer is selected from the group comprising polytetrafluorethylene, ethylene-tetrafluorethylene (ETFE), polyperfluoralkoxytetrafluorethylene, polyfluorinated ethylene-propylene, poly(ethylentetrafluorethylene), polyvinylfluoride, polyvinylidenfluoride, polychlortrifluorethylene, poly(ethylenchlortrifluorethylene), 2,2-bistrifluormethyl-4,5-difluor-1,3-dioxol and/or mixtures thereof.

Preferred fluorpolymers are selected from the group comprising 2,2-Bistrifluormethyl-4,5-difluor-1,3-dioxol, available under the trade name Teflon® for example, AF, Ethylene-tetrafluorethylene, and/or Polyvinylidenfluoride (PVDF), especially preferred is 2,2-Bistrifluormethyl-4,5-difluor-1,3-dioxol.

It is especially advantageous for the fluoropolymer 2,2 Bistrifluormethyl-4,5-difluor-1,3-dioxol to be soluble in perfluorinated hydrocarbons, for example selected from the group comprising perfluorocyclooxanone C₈F₁₆O and/or perfluorodecaline and to be able to be applied via a solution.

It is preferable for the content of fluoropolymer to range from ≧0.5 wt. % to ≦4 wt. %, preferably to range from ≧1 wt. % to ≦2 wt. %, preferably to range from ≧1 wt. % to ≦1.5 wt. %, in relation to the total weight of the coating agent. It has been shown that especially a content ranging from ≧1 wt. % to ≦1.5 wt. % can lead to coating thicknesses of the embodied fluoropolymer coating of 5 μm or less being able to be embodied.

It is especially of advantage that a fluoropolymer coating of a thickness of 5 μm or less leads to no or only a very small additional thermal conductivity resistance of the coated condenser.

In the especially preferred embodiment of the coating agent the coating material is a silicon, preferably a silicon resin, preferably in precondensed form, a silicon elastomer or silicon rubber. Silicon rubber can contain polydiorganosiloxane as its basic polymer, which exhibit cross-linking reactions of accessible groups. Preferred are liquid or dispersed silicon-rubber components which are able to be vulcanized via addition cross-linking Especially preferred are single-component cold-hardening silicone rubber dispersions Especially preferred are liquid, sprayable silicone rubber dispersions.

Preferably the solid content of silicone ranges from ≧10 wt. % to ≦25 wt. %, preferably ranges from ≧15 wt. % to ≦22 wt. %, in relation to the total weight of the coating agent. It has been shown that especially a solid content ranging from ≧15 wt. % to ≦22 wt. % relative to the total weight of the coating agent can lead to a coating thickness of the coating to be embodied ranging from ≧400 nm to ≦800 nm.

In preferred embodiments the silicone is present on the basis of a dispersion of silicone rubber. Preferably usable for example are silicone rubber dispersions available under the trade name Powersil® from Wacker, especially Powersil® 567.

In also especially preferred embodiments of the coating agent the coating agent contains polyurethane-forming components as coating material.

Preferred polyurethane-forming components are selected from the group comprising isocyanate and/or polyols. The isocyanates and polyols can be used in a stoichiometric ratio, or isocyanate or polyols can be present in surplus.

Usable isocyanates are preferably aliphatic and/or aromatic polyisocyanates, preferably diisocyanates selected from the group comprising 1,3-diisocyanatobenzole, 2,4- and 2,6-toluylendiisocyanate, 1,6-hexamethylendiisocyanate, 4,4- and 2,4-diphenylmethandiisocyanate, naphthylendiisocyanate, xylylendiisocyanate, isophorondiisocyanate, paraphenyldiisocyanate, dicyclohexylmethandiisocyanate, cyclohexyldiisocyanate, polymethylpolyphenylisocyanate, 1,6-dodecamethylendiisocyanate, 1,4-Bis(isocyanatocyclohexyl)methane, pentamethylendiisocyanate, trimethylendiisocyanate and/or triphenylmethandiisocyanate. Isophorondiisocyanate is preferred. The use of aliphatic polyisocyanates is especially preferred.

Usable polyols are preferably selected from the group comprising polyacrylate, polyetherpolyole, polyesterpolyole and/or low-molecular polyols, for example di-, tri- or polyalcohols. The use of polyesterpolyols is preferred, especially for example more or less branched polyester polyols obtainable by conversion with dicarbonic acid. The use of weakly branched hydroxyl group containing polyesters is especially preferred.

The isocyanates and polyol compounds that are preferably used are preferably available in wet-chemically processable, preferably liquid form.

Preferably the content of polyurethane-forming components ranges from ≧4 wt. % to ≦25 wt. %, preferably ranges from ≧5 wt. % to ≦20 wt. %, preferably ranges from ≧10 wt. % to ≦15 wt. %, in relation to the total weight of the coating agent.

In preferred embodiments a silicon-oxide-sol is mixed with the coating agent containing isocyanate and polyol components. Usable silicon-oxide sols can feature functionalizing methyl, phenyl and/or fluoro groups.

It is especially preferred for the silicon-oxide sol to be present in the faun of a colloidal dispersion system containing SiO₂ nanoparticles.

In preferred embodiments the coating agent comprises:
Polyurethane-forming components, preferably selected from the group comprising isocyanates and/or polyols, and
Silicon-oxide sol in the form of a colloidally-dispersed system containing SiO₂, preferably ranging from ≧1 wt. % to ≦10 wt. %, preferably ranging from ≧3 wt. % to ≦8 wt. %, especially preferably ranging from ≧5 wt. % to ≦6 wt. %, in relation to the total weight of the polyol and isocyanate components.

Preferably usable SiO₂ sols contain SiO₂ nanoparticles, preferably suspended in butylacetate. Preferably the SiO₂ particles or nanoparticles are hydrophobed on their surface, for example by methyl, phenyl and/or fluorosilane compounds.

The advantage of using SiO₂ sols containing SiO₂ nanoparticles lies especially in the fact that the SiO₂ nanoparticles in the sol are not present in agglomerated form but colloidal. The advantage is further that the SiO₂ nanoparticles are able to be introduced via the sol by admixture and agitation into the coating agent containing isocyanate and polyol components. Preferably isocyanate and polyol components and SiO₂-sols are dissolved or dispersed in mixable, preferably identical solvents, preferably butylacetate. This can

provide a homogeneous distribution of the SiO₂ nanoparticles in the coating agent, by which a corresponding homogeneous distribution in the polyurethane-based lacquer is made possible.

An addition of SiO₂ nanoparticles can in an advantageous manner particularly increase the hydrophobicity of the polyurethane-based lacquer.

Furthermore the advantage can be provided of especially thin and/or smooth coatings being able to be produced on the basis of polyurethane lacquer.

Preferably the coating agent comprises:
Polyurethane-forming components, preferably selected from the group comprising isocyanates and/or polyols, and
Silicon-oxide sol, preferably ranging from ≧1 wt. % to ≦10 wt. %, preferably ranging from ≧3 wt. % to ≦8 wt. %, especially preferably ranging from ≧5 wt. % to ≦6 wt. %, in relation to the total weight of the polyol and isocyanate components.

It was able to be established that an admixture of a silicon-oxide sol, especially ranging from ≧3 wt. % to ≦8 wt. %, relative to the total weight of the polyol and isocyanate components, can lead to improved anti-adhesion properties or anti-stick properties of the coating on metallic condenser surfaces.

An advantage that can be implemented by the admixture of a silicon-oxide sol is an improvement in the hydrophobicity of the coating. A further advantage lies in the fact that, by admixture of a silicon-oxide sol, a homogeneous distribution of the silicon-oxide, preferably SiO₂ in the coating agent can be achieved. This makes it possible for the polyurethane-based lacquer embodied to have a homogeneous distribution of the SiO₂ and thus homogeneous hydrophobic properties.

Preferred solvents for the polyurethane-forming components and/or the silicone-oxide sol are esters, ketones, aromatic hydrocarbons and/or their mixtures. Further preferred solvents are preferably selected from the

group comprising alkyl-acetates. Especially preferred solvents are preferably selected from the group comprising ethylacetate, butylacetate, 1-methoxy-2-propylacetate, methylisobutylketone, toluol, xylol, acetone, methylethylketone, cyclohexanone and/or mixtures thereof Especially preferred is butylacetate.

Preferably the solvent of the coating agent is selected from the group water, alkylacetate, preferably selected from the group comprising ethylacetate, 1-methoxy-2-propylacetate and/or butylacetate, ketones, preferably selected from the group comprising acetone, methylisobutylketone, cyclohexanone and/or 2-butanone, alcohols, preferably selected from the group comprising methanol, ethanol, isopropanol, butanol, ethylhexanol and/or methoxypropanol, perfluorinated hydrocarbons, preferably selected from the group comprising perfluorocyclooxanone and/or perfluorodecaline, and/or mixtures thereof. The solvent of the coating agent is further preferably selected from the group of the aromatic hydrocarbons comprising toluol and/or xylol.

In preferred embodiments a hydrophobic coating with a coating thickness ranging from ≧100 nm to ≦5 μm, preferably ranging from ≧200 nm to ≦2 μm, preferably ranging from ≧300 nm to ≦1 μm, especially preferably ranging from ≧400 nm to ≦800 nm, is applied to the condenser.

The specification of the coating thickness here relates to the coating thickness in the dried or hardened state of the coating.

Of advantage when using the coating agent for manufacturing a hydrophobic coating is especially that very thin and/or very smooth coatings are able to be produced.

One advantage of the method lies in the fact that the inventive content of the coating material of the coating agent enables very thin coatings to be applied evenly to a condenser.

In preferred embodiments the coating agent is applied by using wet-chemistry methods selected from the group comprising (electro) dipping, injecting, molding, painting, spraying, flow coating and/or wet lacquering. Preferably the coating agent is able to be applied by methods selected from the group comprising immersion and/or spraying.

Furthermore, the coating agent can be applied with wet chemistry by means of rolling or bell rotation.

Further advantages are provided by the fact that wet chemistry methods make it possible to apply the coating to the condenser later. Furthermore wet-chemistry methods need a significantly lower technical outlay than vacuum methods and are associated with correspondingly lower costs. Of especial advantage is the fact that coating materials can be better utilized. This means that material savings are advantageously possible. In addition wet-chemistry coating methods exhibit a greater flexibility in relation to the geometry of the condenser to be coated, so that

non-planar and complex condenser geometries can be evenly coated.

The wet-chemical application of a coating also has the advantage that the resistance of the coating to scratches can be improved in this way.

Before application the surface of the condenser surfaces to be coated can be pre-treated, in particular the condenser surfaces to be coated can be degreased, for example with solvents selected from the group comprising acetone and/or isopropanol and/or with neutral cleaners, for example phosphates, cationic tensides and phosphonate-containing neutral cleaners.

Furthermore condenser surfaces to be coated can be etched before the application of the coating agent, for example by being treated with an acid selected from the group comprising liquid acids, salt acids and or sulphuric acids, preferably with a mixture of acids selected from the group comprising liquid acids, salt acids and/or sulphuric acids with water. An improved adhesion of the coating can be produced by this.

After the wet-chemical application of the coating agent the coating will be dried and/or hardened. Preferably the coating will be dried before being hardened. The drying temperatures are preferably

room temperature, preferably ranging from ≧18° C. to ≦25° C.

Preferably the drying time ranges from ≧10 minutes to ≦30 minutes, preferably ranging from ≧15 minutes to ≦30 minutes.

The drying can contribute to solvents being able to escape or evaporate before the coating dries out.

There can also be provision for drying and hardening to occur at an even temperature, for example with higher temperatures ranging from ≧30° C. to ≦200° C., preferably at room temperature, preferably ranging from ≧18° C. to ≦25° C.

The coating is preferably hardened photochemically or thermally, preferably at temperatures ranging from ≧50° C. to ≦350° C., preferably ranging from ≧70° C. to ≦200° C., especially preferably ranging from ≧80° C. to ≦100° C.

Preferably the duration of the hardening ranges from ≧15 minutes to ≦2 hours, preferably ranging from ≧20 minutes to ≦1.5 hours, especially preferably ranging from ≧30 minutes to ≦1 hour.

A hardening time of especially ≧30 minutes to ≦1 hour can contribute to the coated substrate exhibiting an improved corrosion resistance.

A coating for example with an aqueous dispersion of fluoropolymer resin can also be embodied by hardening at high temperatures, for example by sintering at temperatures ranging from ≧200° C. to ≦500° C., preferably ranging from ≧300° C. to ≦400° C.

The invention also relates to hydrophobic coatings to obtain dropwise condensation of condensers, with the coating being selected from the group comprising silicon-oxide-based sol-gel lacquers, especially SiO₂ fluoropolymers, silicones and/or polyurethane-based lacquers, obtained by using the inventive method, and with the coating featuring a coating depth ranging from ≧100 nm to ≦5 μm.

In preferred embodiments the coating depth ranges from ≧200 nm to ≦2 μm, preferably ranges from ≧300 nm to ≦1 μm, especially preferably ranges from ≧400 nm to ≦800 nm.

The specification of the coating thickness here relates to the coating thickness in the dried and/or hardened state of the coating.

It is of particular advantage for the coating of condensers for thin, hydrophobic coatings selected from the group comprising sol-gel lacquers based on silicon-oxide, especially SiO₂, fluoropolymers, silicones and/or polyurethane-based lacquers to be able to be applied to condensers by the inventive method which can withstand the temperature fluctuations and dimensional changes occurring in condensers. This is of great advantage especially for the long-term stability of the coating of condensers.

In addition it is of advantage, especially for the coating of condensers, for thin hydrophobic coating selected from the group comprising silicon-oxide-based sol-gel lacquers, especially SiO₂, fluoropolymers, silicones and/or polyurethane-based lacquers to be able to exhibit a good impact resistance and thereby to provide protection for the condenser.

Within the meaning of the invention, the term “condenser” is to be understood as condensation surfaces, preferred condensers are vapor condensers of steam turbines for example. Especially preferred condensers are vapor condensers for separating non-metallic vapors, especially water vapor.

Surprisingly it has been found that coatings selected from the group comprising silicon-oxide-based sol-gel lacquers, especially SiO₂, fluoropolymers, silicone and/or polyurethane-based lacquers produced using an inventive method exhibit a good stability, especially against the effects of water. In particular these coatings exhibit a good adhesion to metallic condenser surfaces, especially to titanium and/or steel. A further advantage of the coatings can be provided by these coatings being able to be embodied with an improved smoothness.

A further advantage of the coatings selected from the group comprising silicon-oxide-based sol-gel lacquers, especially Si_{O}2, fluoropolymers, silicone and/or polyurethane-based lacquers is provided by their ability to increase the corrosion-resistance of the coated condenser. This is of advantage especially for condensers of steam turbine, since with increased temperatures and influence of moisture corrosion of the metallic condensers frequently occurs.

Preferred fluoropolymer coatings comprise 2,2-bistrifluormethyl-4,5-difluor-1,3-dioxol. Fluoropolymer coatings comprising 2,2-bistrifluormethyl-4,5-difluor-1,3-dioxol are advantageously able to be stored and are wear-resistant. Furthermore these can embody a very smooth coating.

A preferred sol-gel lacquer is obtainable by drying and/or hardening a sol-gel material, as detailed above. Preferably the sol-gel lacquer features built-in fluoroalkoxysilanes.

In a preferred embodiment the coating is embodied from a silicone, especially a silicone resin of a silicone rubber.

In especially preferred embodiments the coating is embodied for a polyurethane-based lacquer.

One advantage that coatings embodied from silicone and coatings embodied from a polyurethane-based lacquer can provide lies in the fact that these coatings can exhibit an especially good resistance to water, especially to heated or hot water. This makes it possible for coating embodied from silicone and coatings embodied from a polyurethane-based lacquer to be used in an advantageous manner in vapor condensers.

It has been able to be established that especially coatings selected from the group comprising silicone and/or polyurethane-based lacquer exhibit an especially good stability of hydrophobicity in relation to storage in water at temperatures of 80° C. It has thus been able to be established that especially silicone coatings and polyurethane-based lacquer, even after 1000 hours, exhibit no or only slight deviations in hydrophobicity, measured as a change of the contact angle in relation to water.

Preferably the polyurethane-based lacquer is a silicon-oxide-modified, especially SiO₂-modified polyurethane lacquer. In quite particularly preferred embodiments the polyurethane-based lacquer contains a silicon-oxide component. A silicon-oxide component can especially be included by a silicon-oxide sol being added to the coating agent.

In other especially preferred embodiments the polyurethane-based lacquer contains a silicon-oxide component containing SiO₂ nanoparticles.

The advantage of a silicon-oxide component containing SiO₂ nanoparticles lies especially in that fact that an addition of SiO₂ nanoparticles can advantageously increase the hydrophobicity of the polyurethane-based lacquer.

It was able to be established that a polyurethane-based lacquer containing silicon-oxide, especially SiO₂, exhibits an increase in hydrophobicity. In particular polyurethane-based lacquers containing silicon oxide show especially good long-lasting anti-adhesive properties.

The present invention further relates to a hydrophobically coated condenser to obtain dropwise condensation produced in accordance with the inventive method.

In preferred embodiments the hydrophobically-coated condenser can feature hydrophobic coatings to obtain dropwise condensation, with the coating being selected from the group containing Silicon-oxide-based sol-gel lacquers, especially SiO₂, fluoropolymers, silicones and or polyurethane-based lacquer, and with the coating having a coating thickness ranging from ≧100 nm to ≦5 μm, preferably ranging from ≧200 nm to ≦2 μm, preferably ranging from ≧300 nm to ≦1 μm, especially preferably ranging from ≧400 nm to ≦800 nm.

One advantage of the hydrophobically-coated condenser lies in the fact that thin hydrophobic coatings of the condenser can be made available. This can lead in an advantageous manner to no or to only a very slight additional thermal conductivity resistance of the coated condenser.

It is also of particular advantage for the coating of condensers for thin, hydrophobic coatings selected from the group comprising silicon-oxide-based sol-gel lacquers, especially SiO₂, fluoropolymers, silicones and/or polyurethane-based lacquers to be able to be applied to condensers by the inventive method which can withstand the temperature fluctuations and dimensional changes occurring in condensers. This is of great advantage especially for the long-term stability of the coating of condensers.

In addition it is of advantage, especially for the coating of condensers, for thin hydrophobic coating selected from the group comprising silicon-oxide-based sol-gel lacquers, especially polyurethane-based SiO₂, fluoropolymers, silicones and/or lacquers to be able to exhibit a good impact resistance and thereby to provide protection for the condenser.

The present invention further relates to a coating agent for establishing a hydrophobic coating of condensers to obtain dropwise condensation, with the coating agent comprising a liquid solvent and at least one coating material selected from the group comprising silicon-oxide-based sol-gel materials, fluoropolymers, silicones and/or polyurethane-forming components with, in relation to the total weight of the coating agent in each case:
the solid content of the silicon-oxide-sol-based sol-gel material ranging from ≧0.5 wt. % to ≦20 wt. %; and/or
the fluorocarbon polymer content ranging from ≧0.1 wt. % to ≦5 wt. %; and/or
the solid content of silicon ranging from ≧5 wt. % to ≦30 wt. %; and/or
the content of polyurethane-forming components ranging from ≧3 wt. % to ≦30 wt. %.

In this case reference is made for all aspects of the coating agent to the present description.

Preferably the coating agent comprises:
Polyurethane-forming components, preferably selected from the group comprising isocyanates and/or polyols, and
Silicon-oxide sol, preferably ranging from ≧1 wt. % to ≦10 wt %, preferably ranging from ≧3 wt. % to ≦8 wt. %, especially preferably ranging from ≧5 wt. % to ≦6 wt. %, relative to the total weight of the polyol and isocyanate components.

An admixture of a silicon-oxide sol, especially ranging from ≧3 wt. % to ≦8 wt. %, relative to the total weight of the polyol and isocyanate components, can lead to improved anti-adhesion properties or anti-stick properties of the coating on metallic condenser surfaces.

A further advantage that can be implemented by the admixture of a silicon-oxide sol is an improvement in the hydrophobicity of the coating

In further preferred embodiments the coating agent comprises:
Polyurethane-forming components, preferably selected from the group comprising isocyanates and/or polyols, and
Silicon-oxide sol in the form of a colloidally dispersed system containing SiO₂ nanoparticles, preferably ranging from ≧1 wt. % to ≦10 wt. %, preferably ranging from ≧3 wt. % to ≦8 wt. %, especially preferably ranging from ≧5 wt. % to ≦6 wt. %, in relation to the total weight of the polyol and isocyanate components.

An addition of SiO₂ nanoparticles can in an advantageous manner particularly increase the hydrophicity of the polyurethane-based lacquer.

Furthermore the advantage can be provided that, by adding SiO₂ nanoparticles, especially thin and/or smooth polyurethane-based lacquer coatings are able to be produced.

Examples which serve to illustrate the present invention are given below.

### EXAMPLE 1

1 mm thick titanium sheets (ASTM B265 Grade 2) were used as a substrate for the coating. These were degreased with isopropanol, obtainable for example under the brand name P3 Neutracare 800 from Henkel, before application of the coating.

To produce the coating agent 3.4 g polyesterpolyol, obtainable for example under the trade name Desmophen® 670 from Bayer AG, and 1.8 g isophorondiisocyanate, obtainable for example under the trade name Desmodur® N3390 from Bayer AG, were mixed with 0.3 g SiO₂ sol, obtainable for example under the trade name H 4033 from FEW Chemicals, and adjusted with 20 g butylacetate to a solid content of around 11 wt. % in relation to the total weight of the coating agent.

The titanium sheet was coated by dipping at a speed of 35 mm/min to 75 mm/min in a laboratory dip coater (from T_O_P Oberflächen GmbH, Würzburg). After the coating the sheet was dried for 10 minutes at a room temperature of 23° C. and subsequently the coating was hardened for 1 hour at 80° C. The thickness of the lacquer amounted to 715 mm.

The titanium sheets coated in this way were stored at 80° C. for 1000 hours in deionized water, with the contact angle to water being determined after 168, 336, 598, 819 and 1010 hours in accordance with the DSA (Drop Shape Analysis) method with the measurement method of “lying droplets” on a DSA 100 contact angle measurement device from Krüss at 23° C. using 2 μl droplets of deionized water as a measure of the hydrophobicity.

It was evident than after appr. 1000 hours of storage, the contact angle of the SiO₂-modified polyurethane lacquer to water still lay above 85°.

### EXAMPLE 2

1 mm thick titanium sheets (ASTM B265 Grade 2) were used as a substrate for the coating. These were degreased with isopropanol, obtainable for example under the brand name P3 Neutracare 800 from Henkel, before application of the coating.

To produce the coating agent a silicone-rubber dispersion, available for example under the brand name Powersil® 567 from Wacker Chemie, was adjusted with 2-butanone to a solid content of around 22 wt. % in relation to the total weight of the coating agent.

The titanium sheet was coated by dipping at a speed of 35 mm/min to 75 mm/min in a laboratory dip coater (from T_O_P Oberflächen GmbH, Würzburg). After the coating the sheet was dried for 10 minutes at a room temperature of 23° C. and subsequently the coating was hardened for 1 hour at 80° C. The thickness of the lacquer amounted to 475 mm.

The titanium sheets coated in this way were stored at 80° C. for 1000 hours in deionized water, with the contact angle to water being determined after 168, 336, 598, 819 and 1010 hours in accordance with the DSA (Drop Shape-Analysis) method with the measurement method of “lying droplets” on a DSA 100 contact angle measurement device from Krüss at 23° C. using 2 μl droplets of deionized water as a measure of the hydrophobicity.

It was evident than after appr. 1000 hours of storage, the contact angle of the silicone coating to water was almost unchanged at above 110°.

By contrast the uncoated titanium sheet, after storage for 1000 hours in deionized water at 80° C. showed a contact angle to water of appr. 15°.

The results show that the coatings exhibit a good stability and hydrophobicity in a damp environment, as obtains in vapor condensers.

1.-16. (canceled)

17. A method for producing a hydrophobic coating for condensers to obtain dropwise condensation, comprising:
applying a coating agent is to the condenser using a wet-chemical method, comprising a liquid solvent and at least one coating material selected from the group comprising silicon-oxide-based sol-gel materials, fluoropolymers, silicones and/or polyurethane-forming components with, in relation to the total weight of the coating agent in each case:
a solid content of the sol-gel material based on silicon oxide sol ranges from ≧0.5 wt. % to ≦20 wt. %, and/or
a fluorocarbon polymer content ranging from ≧0.1 wt. % to ≦5 wt. %, and/or
a solid content of silicon ranges from ≧5 wt. % to ≦30 wt. %, and/or
a content of polyurethane-forming components ranges from ≧3 wt. % to ≦30 wt. %.

18. The method as claimed in claim 17, wherein the wet-chemical method is selected from the group consisting of (electro) dipping, injection, molding, painting, spraying, flow coating, lacquering and combinations thereof.

19. The method as claimed in claim 17, wherein the solid content of the silicon-oxide based sol-gel material ranges from ≧5 wt. % to ≦15 wt. % in relation to the total weight of the coating agent.

20. The method as claimed in claim 17, wherein the content of fluoropolymer ranges from ≧0.5 wt. % to ≦4 wt. % in relation to the total weight of the coating agent.

21. The method as claimed in claim 17, wherein the fluoropolymer is selected from the group consisting of:
polytetrafluorethylene,
ethylene-tetrafluorethylene (ETFE),
polyperfluoralkoxytetrafluorethylene,
polyfluorinated ethylene-propylene,
poly(ethylentetrafluorethylene),
polyvinylfluoride,
polyvinylidenfluoride,
polychlortrifluorethylene,
poly(ethylenchlortrifluorethylene),
2,2-Bistrifluormethyl-4,5-difluor-1,3-dioxol and mixtures thereof.

22. The method as claimed in claim 17, wherein the solid content of silicone ranges from ≧10 wt. % to ≦25 wt. % in relation to the total weight of the coating agent.

23. The method as claimed in claim 17, wherein the silicone is present based on a dispersion of silicone rubber.

24. The method as claimed in claim 17, wherein the content of polyurethane-forming components ranges from ≧4 wt. % to ≦25 wt. % in relation to the total weight of the coating agent.

25. The method as claimed in claim 17, wherein the coating agent comprises:
polyurethane-forming components selected from the group consisting of isocyanates polyols, silicon-oxide sol in the form of a colloidally dispersed system containing SiO₂ nanoparticles.

26. The method as claimed in claim 17, wherein the coating is applied to the condenser with a thickness ranging from ≧100 nm to ≦5 μm.

27. A hydrophobic coating of condensers to obtain dropwise condensation, comprising:
a condenser; and
a coating agent applied to the condenser using a wet-chemical method and comprising a thickness ranging from ≧100 nm to ≦5 μm, the coating agent selected from the group consisting of silicon-oxide-based sol-gel lacquers, fluoropolymers, silicones polyurethane-based lacquers, and combinations thereof,
in relation to the total weight of the coating agent in each case:
a solid content of the sol-gel material based on silicon oxide sol ranges from ≧0.5 wt. % to ≦20 wt. %, and/or
a fluorocarbon polymer content ranging from ≧0.1 wt. % to ≦5 wt. %, and/or
a solid content of silicon ranges from ≧5 wt. % to ≦30 wt. %, and/or
a content of polyurethane-forming components ranges from ≧3 wt. % to ≦30 wt. %.

28. The hydrophobic coating as claimed in claim 27, wherein a thickness of the coating agent ranges from ≧200 nm to ≦2 μm.

29. The hydrophobic coating as claimed in claim 27, wherein the polyurethane-based lacquer comprises a silicon-oxide component including SiO₂ nanoparticles.

30. The hydrophobic coating as claimed in claim 27, wherein a content of fluoropolymer ranges from ≧0.5 wt. % to ≦4 wt. % in relation to the total weight of the coating agent.

31. The hydrophobic coating as claimed in claim 27, wherein the fluoropolymer is selected from the group consisting of:
polytetrafluorethylene,
ethylene-tetrafluorethylene (ETFE),
polyperfluoralkoxytetrafluorethylene,
polyfluorinated ethylene-propylene,
poly(ethylentetrafluorethylene),
polyvinylfluoride,
polyvinylidenfluoride,
polychlortrifluorethylene,
poly(ethylenchlortrifluorethylene),
2,2-Bistrifluoromethyl-4,5-difluor-1,3-dioxol and
mixtures thereof.

32. The hydrophobic coating as claimed in claim 27, wherein the solid content of silicone ranges from ≧10 wt. % to ≦25 wt. % in relation to the total weight of the coating agent.

33. The hydrophobic coating as claimed in claim 27, wherein the silicone is present based on a dispersion of silicone rubber.

34. A hydrophobically-coated condenser to obtain dropwise condensation produced in accordance with the methods claimed in claim 17.

35. A coating agent for producing a hydrophobic coating of condensers to obtain dropwise condensation, comprising:
a liquid solvent; and
at least one coating material selected from the group comprising silicon-oxide-based sol-gel materials, fluoropolymers, silicones and/or polyurethane-forming components with, in relation to the total weight of the coating agent in each case:
a solid content of the silicon-oxide sol based sol-gel material ranging from ≧0.5 wt. % to ≦20 wt. %, and/or
a fluorocarbon polymer content ranging from ≧0.1 wt. % to ≦5 wt. %, and/or
a solid content of silicone ranging from ≧5 wt. % to ≦30 wt. %, and/or
a content of polyurethane-forming components ranging from ≧3 wt. % to ≦30 wt. %.

36. The coating agent as claimed in claim 35, comprising:
polyurethane-forming components; and
silicon-oxide sol in the form of a colloidally dispersed system containing SiO₂ nanoparticles, preferably ranging from ≧1 wt. % to ≦10 wt. %. relative to the total weight of the polyol and isocyanate components.
